(19) United States
(12) Patent Application Publication
(10) Pub. No.: US 2012/0251816 A1
(43) Pub. Date: Oct. 4, 2012

(54) Foamboard with multi-layer construction

(75) Inventor: Richard J. Repecki, West Harrison, NY (US)

(73) Assignee: Royal Consumer Products, llc

(21) Appl. No.: 13/066,018

(22) Filed: Apr. 4, 2011

(51) Int. Cl. B32B 27/00; B32B 9/00; B32B 3/26

(52) U.S. Cl. 428/319.3; 428/304.4; 428/318.4

(57) ABSTRACT

A foamboard has a polystyrene foam core, first and second base layers respectively adhered to opposite sides of the foam core and first and second outer layers respectively adhered to the first and second base layers. The first and second base layers are polymer film and the outer layers are paper or paperboard. The polymer film base layers are securely adhered to the foam core either as the foam core is formed or by adhesive, and the polymer film base layer provides a smooth surface for securing the paper or paperboard outer layer by adhesive. This provides a more secure attachment of the outerlayers to the foam core.

### FIELD OF THE INVENTION

The invention herein relates to a multi-layer construction of foamboard that has high integrity and durability, and also provides for two-side use.

### BACKGROUND OF THE INVENTION

Foamboard is a graphic display medium suitable for a wide variety of graphic and display uses. It generally consists of a stiff, resilient, extruded polystyrene core sandwiched between two layers of paper. The paper may be bleached, semi-gloss white clay-coated paper, or may be colored paper. Foamboard can be used for projects, presentation of information, temporary signage or the like wherein the user applies graphics thereto, and can also be used for screen printing, mounting, framing and prototype construction.

A significant drawback to typical foamboard construction is that the paper can separate from the form core, particularly at the corners. The separation can occur from handling during the time the foamboard is presented for sale in merchandising racks, from handling in the course of using the foamboard for projects in processing the foamboard for printing or the like, or from handling when transporting and displaying foamboard having a completed project or graphic display thereon.

Therefore, foamboard could be improved if the problem of separation of the surface paper could be solved.

### SUMMARY OF THE INVENTION

The principal object of the invention herein is to provide a foamboard of high integrity and durability.

Another object of the invention herein is to provide foamboard that resists separation of the outer layer.

In carrying out the invention, a foamboard is provided with a foam core, first and second base layers respectively adhered to opposite surfaces of the foam core, and first and second outer layers respectively adhered to the first and second base layers. The core and the first and second base layers are selected for secure adherence to each other by methods that are advantageous with respect to both the base layer and the foam core. The outer layers are paper and are secured to the base layers by adhesives that are cooperative with respect to materials of both the base layers and outer layers.

In certain aspects of the invention, the core is extruded polystyrene, and the base layer is a polymer film adhered to foam core by means such as adhesion to the foam core at the time of formation or adhesive. The polymer films include PVC, ABS and butadiene copolymer films. The adhesive, if used, may be pressure sensitive adhesive.

In other aspects of the invention, the outer layers are paper and may be coated on at least the outer surfaces. The coating may be a clay-based coating, and may include dyes or pigments. The outer layers may be secured to the base layer by pressure sensitive adhesive.

These and other objects and features of the invention will in part appear in the following detailed description of the invention and the claims, taken together with the drawings.

### BRIEF DESCRIPTION OF THE DRAWINGS

FIG. 1 is a cross-sectional view of a foamboard according to the invention herein.

### DETAILED DESCRIPTION OF THE INVENTION

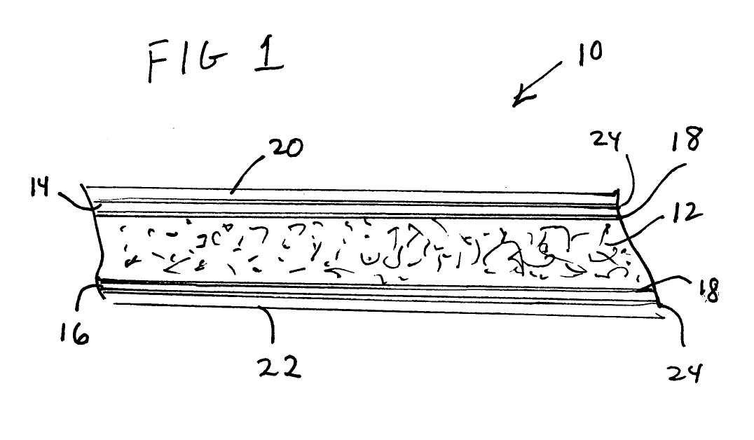

With reference to FIG. 1, a foamboard 10 according to the invention herein is illustrated. It generally comprises a foam core 12, first and second base layers 14 and 16, and first and second outer layers 20 and 22.

The core 12 may be extruded polystyrene, and may be provided in a variety of thicknesses depending on the final use of the board. Foamboard is typically provided in a range of thicknesses from about ⅛ inch to about ½ inch, and the polystyrene core may be slightly less than the total finished thickness of the foamboard to accommodate the additional thickness of the layers adhered thereto. Other foam cores may be utilized, however, polystyrene is advantageous for its resistance to bending and low weight, as well as its resilience. The foam core can also be provided in two layers adhered together.

The foamboard 10 has base layers 14 and 16 respectively adhered to opposite sides of the polystyrene core 12. The base layers are selected to provide a “skin” tightly adhered to the foam core 12. The material of the base layers 14, 16 is selected in conjunction with a method of adhering the base layers to the foam core so that there is a highly secure connection between the base layers and foam core. The base layers 14, 16 are also selected with consideration of adhering outer layers 20 and 22 thereto.

Polymer films are suitable for the base layers 14, 16. Suitable base layer films are plasticized polyvinyl chloride (PVC) film, a plasticized acrylonitrile butadiene polystyrene (ABS), or a plasticized butadiene copolymer film. Other polymer films may be used. The film may be relatively thin, on the order of 0.005-0.030 inches, but may be any desired thickness. The polymer film may also be adhered to the foam core by adhesion to the foam core as it is being formed, or by use of adhesives that are compatable with the foam core 12 and the base layers 14, 16, if the film is not attached as a part of forming the foam core. Adhesive 18 is shown. It is a pressure sensitive adhesive, and acrylic or styrene based adhesives are suitable.

The outer layers 20, 22 are preferably paper or a light weight paperboard, and are adhered to the base layers 14 and 16 by adhesive. They may be in the range of about 0.002-0.008 inches thick, or other thicknesses as desired. The outer surfaces 24, 26 of the outer layers 20, 22 may be coated, for example by a clay coating which contributes to a smoothness of the outer surface and its receptivity to inks for applying indicia or other graphics to the outer surfaces. The outer layers 20, 22 may be coated on two-sides, if desired, and also depending on the compatibility of the adhesive used to adhere the outer layers 20, 22 to the base layers 14, 16. Adhesive 24 is shown. It is preferably a pressure sensitive adhesive compatable with the polymer film base layer, such as an acrylic or styrene based adhesive. It will be appreciated that as a part of making the foamboard 10, it is compressed to assure even thickness and flat surfaces.

The foregoing construction is advantageous in that a paper outer layer attached directly to a foam core has a tendency to separate or peel. This is at least partially caused by a weak or irregular surface of the foam core as well as relatively weak surface integrity of a paper outer layer, and also by an uneven effect of adhesives or adherence of the foamcore to the papar layer used in this construction. The improved foamboard 10 overcomes this difficulty by tightly adhering the base layers 14, 16 to the foam core 12, such that the adhesion of the base layers to the foam core is higher than the strength of direct adhesion of paper or paperboard outer layers to the foam core. The base layers 14, 16 then provide a smooth and receptive substrate for the attaching outer layers 20, 22 which are adhered to the base layers 14, 16 more tightly than is possible when adhering outer layers directly to a foam core.

Accordingly, an improved foamboard has been described which admirably fulfills the objects of the invention. It will be appreciated that the embodiment described is illustrative only, and that various changes may be made without departing from the spirit and scope of the invention, which is limited only by the following claims.

I claim:

1. A foamboard comprising:
A) a foam core;
B) first and second base layers respectively adhered to opposite sides of the foam core; and
C) first and second outer layers respectively adhered to the first and second base layers.

2. A foamboard as defined in claim 1 wherein the foam core is polystyrene.

3. A foamboard as defined in claim 2 wherein the first and second base layers are polymer film.

4. A foamboard as defined in claim 3 wherein the polymer film is one of polyvinyl chloride film, acrylonitrile budadrene styrene film, and a budadrene copolymer film.

5. A foamboard as defined in claim 3 wherein the polymer film is secured to the foam core by adhesion to the foam core at the time of manufacture.

6. A foamboard as defined in claim 3 wherein the polymer film is adhered to the foam core by adhesive.

7. A foamboard as defined in claim 6 wherein the adhesive is a pressure sensitive adhesive.

8. A foamboard as defined in claim 7 wherein the pressure sensitive adhesive is one of an acrylic based adhesive or a styrene based adhesive.

9. A foamboard as defined in claim 3 wherein the outer layers are paper.

10. A foamboard as defined in claim 9 wherein the paper is clay coated.

11. A foamboard as defined in claim 9 wherein the paper outer layers are secured to the polymer film base layers by pressure sensitive adhesive.

12. A foamboard as defined in claim 11 wherein the pressure sensitive adhesive is one of an acrylic based adhesive and a styrene based adhesive.

13. A foamboard as defined in the claim 12 wherein the outer layers are paperboard.

14. A foamboard as defined in claim 12 wherein the paperboard is clay coated.

15. A foamboard as defined in claim 14 wherein the paperboard outer layers are secured to the polymer film base layers by pressure sensitive adhesive.

16. A foamboard as defined in the claim 1 wherein the outer layers are one of paper and paperboard.

17. A foamboard as defined in claim 16 wherein the outer layers are clay coated.

18. A foamboard as defined in claim 16 wherein the outer layers are secured to the polymer film base layers by pressure sensitive adhesive.

19. A foamboard as defined in claim 18 wherein the pressure sensitive adhesive is one of an acrylic based adhesive or a styrene based adhesive.

20. A foamboard as defined in the claim 1 wherein the first and second base layers are adhered to the foam core by adhesive compatible with both the first and second base layers and the foam core, and the outer layers are adhered to the first and second base layers by adhesive compatible with both the first and second base layers and the first and second outer layers.
